(19) United States
(12) Patent Application Publication
(10) Pub. No.: US 2025/0362232 A1
(43) Pub. Date: Nov. 27, 2025

(54) Optical System Having a Filter Carrier

(71) Applicant: Robert Bosch GmbH, Stuttgart (DE)

(72) Inventor: Ingo Ramsteiner, Ettlingen (DE)

(21) Appl. No.: 18/874,751

(22) PCT Filed: Jun. 14, 2023
(86) PCT No.: PCT/EP2023/065905

§ 371 Date: Dec. 13, 2024

(30) Foreign Application Priority Data
Jun. 22, 2022 (DE) 10 2022 206 219.1

(51) Int. Cl. G01N 21/64; G02B 7/00

(52) U.S. Cl. CPC G01N 21/645; G02B 7/006; G01N 2021/6471

(57) ABSTRACT

The disclosure relates to an optical system, which comprises a light source, a detector and a sample holder. A first beam path runs from the light source to the sample holder, and a second beam path, which is separated from the first beam path, runs from the sample holder to the detector. The optical system also has a filter carrier, which has a plurality of filters. Filter pairs are formed by two filters. The filter carrier is arranged in the optical system such that the first beam path runs through one filter of a filter pair and the second beam path runs through the other filter of the same filter pair.

### OPTICAL SYSTEM HAVING A FILTER CARRIER

The present invention relates to an optical system having a filter carrier which has a plurality of filters joined together in filter pairs, and to the use of the filter carrier in an optical system.

### PRIOR ART

In optical systems, individual components such as optical filters are automatically replaced during operation. For this purpose, mechanical exchange units are used that replace the filters before an opening. An example of this is filter wheels, where the filters are arranged on a rotatable disc and are rotated in front of the opening. In many optical systems, two openings of two different beam paths are provided. The two filters are selected depending on each other and form a filter pair. A trivial solution is to use two filter wheels, wherein one filter wheel covers each opening and only the filters for the corresponding opening are arranged on each filter wheel. The two filter wheels may then be provided with a common drive.

In U.S. Pat. No. 6,313,960 B2, it is provided that all filters are arranged on a common filter wheel. The filters are arranged along a circle about the center of rotation of the filter wheel at the same distance from it. The two filters of a filter pair are arranged opposite each other on a line with the center of rotation. In a housing, the two openings are arranged such that they are each spaced apart from the center of rotation around the radius of the circle of the filters and are also arranged on a line with the center of rotation. A filter pair therefore occupies both openings simultaneously. The filter wheel is used here for two identical beam paths.

“Filter cubes”, which have two filters and a dichroic mirror or a beam splitter, are also known from fluorescence microscopy. The filter cubes are mounted on one wheel, allowing both filters to be changed simultaneously. One filter is arranged in the light path from the source to the dichroic mirror and a further filter is arranged in the light path between the dichroic mirror and the detector. A common beam path is used from the dichroic mirror to the sample.

### DISCLOSURE OF THE INVENTION

An optical system is proposed comprising a light source, a detector and a sample holder. A first beam path runs from the light source to the sample holder and a second beam path runs from the sample holder to the detector. The first and second beam paths meet only at the sample holder, but are otherwise spatially separated. The light from the light source and the light to the detector therefore run along separate paths.

The optical system also has a filter carrier comprising a plurality of optical filters. Two filters are selected to match each other for a respective application and form a filter pair. The filters of the filter pair may preferably block different frequency ranges. The filter carrier is arranged in the optical system such that the first beam path runs through one filter of a filter pair and the second beam path runs through the other filter of the same filter pair. Thus, one side of the filter pair is associated with the first beam path from the light source to the sample and the other side of the filter pair is associated with the second beam path from the sample to the detector. One side of the filter pairs is to be understood to mean that these filters are associated with the same beam path and thus with the same opening and do not form a common filter pair with each other. The filter carrier makes it easier to switch between the filter pairs and the selected matching filters of a filter pair are brought into the two completely separate beam paths.

In particular, the optical system is a fluorescence measurement system. An excitation light from the light source runs along the first beam path and through the first filter of the filter pair to the sample. The filter may be a band pass filter that only allows the excitation light to pass through. The excitation light stimulates fluorescence in the sample, thereby radiating fluorescence light. The fluorescent light is introduced into the second beam path and runs separate from the excitation light along the second beam path through the second filter of the filter pair to the detector that receives the fluorescent light. The second filter allows the fluorescent light to pass through and blocks the frequencies of the excitation light so that any scattered excitation light does not penetrate the detector. In a fluorescence measurement system, the filter pairs may be selected depending on the respective excitation light. Here, use of the filter carrier is advantageous, as when the excitation light changes, the filter pair can be changed in a simple manner.

In one variant, the filter carrier may be a filter wheel. The filter wheel is preferably a disc, in particular a circle disc, and the filters are arranged on the end face. In particular, the filters have a square shape. Such a square shape is easier to manufacture than, for example, a circular shape. The filter wheel may be rotated about a center of rotation, which is preferably at the center point of the filter wheel. As a result, the filters are moved and can be aligned with a corresponding opening. All filters belonging to one side of the filter pairs are arranged at the same distance to the center of rotation. This applies to both sides of the filter pair. One side of the filter pairs is to be understood to mean that these filters are associated with the same beam path and thus with the same opening and do not form a common filter pair with each other. For each side, the corresponding opening is arranged at the same distance as the filters to the center of rotation so that the filters of this side can be aligned with the associated opening. Preferably, the filters are equally spaced apart from their neighbors on the same side. This allows the filter wheel to be rotated at the same angle when changing the filters.

Preferably, however, the two filters of a filter pair are not at the same distance to the center of rotation. Thus, the filters of the filter pair do not lie on a circle with the same radius about the center of rotation, but can be distributed on the filter wheel. Alternatively or additionally, it may be provided that the two filters of a filter pair and the center of rotation do not lie on a common straight line. Thus, the filters of the filter pair are offset relative to the center of rotation. As a result, the area of the filter wheel is better utilized for the arrangement of the filters in both ways. Accordingly, the selection of the diameter of the filter wheel can be smaller, which is particularly advantageous in terms of the small design space, but also the lower material costs. A combination of the two ways additionally improves the utilization of the area. The openings are arranged such that they are aligned with a filter pair in at least one position of the filter wheel. As described above, as the filters of one side of the filter pairs are arranged for each of the two sides at the same distance to the center of rotation, the respective filters are aligned with the openings by rotating the filter wheel.

A preferred arrangement of the filters on the filter wheel is two concentric circles with different radii around the center of rotation. The filters on one side of the filter pairs are arranged along one circle and the filters on the other side are arranged along the other circle. As the two circles have different radii, the filters of a filter pair have different distances to the center of rotation. Additionally, the filters may be arranged on the circles such that the filters of a filter pair do not form a common line with the center of rotation.

For example, eight filters forming four filter pairs may be provided. A particularly preferred arrangement of four filter pairs on the filter wheel is a square, the center point of which lies in the center of rotation of the filter wheel. The filters are arranged along the sides, including the corners, of the square and are preferably equidistantly distributed on the sides. In particular, the filters of one side of the filter pairs are arranged at the corners of the square. Thus, one of the circles described above runs through the corners of the square. The filters of the other side of the filter pairs are then arranged at a point on the side of the square, for example the center point of the respective side. Thus, the other circle runs through these points. Due to its symmetry, the square provides an easy way of arranging the filters of a filter pair at different distances from the center of rotation while simultaneously arranging the filters of one side of the filter pairs at the same distance to the center of rotation. With square filters in particular, this arrangement can save space on the filter wheel compared with an arrangement along just one circle. The eight filters may be advantageously arranged along the sides of the square, in that one of the filters of the filter pair is arranged in a corner of the square and the associated other filter is arranged on one side of the square, particularly preferably in the center point of the side. Accordingly, all filters of one side of the filter pairs are arranged in the corners of the square and all filters of the other side of the filter pairs are arranged on the sides of the square, particularly preferably in the center point of the sides. The distance from the center of rotation to a corner of the square is the greatest and is the same for each corner due to symmetry. The distance to one side of the square, and in particular to the center point of the side, is smaller and can also be selected the same for all sides due to the symmetry. In addition, starting from one corner, only the opposite corner of the square and no other points on the sides of the square lie on a common line with the center of rotation.

For example, ten filters forming five filter pairs may be provided, wherein five filters on one side of the filter pairs are arranged along an inner circle on a pentagon and a further five filters of the other side of the filter pairs are arranged along an outer circle on a pentagon. Thus, the five filters on the inner circle form a pentagon and the five filters on the outer circle form a further pentagon that surrounds the first pentagon.

Generally speaking, with n (n∈ [symbol] ) filter pairs, the filters are preferably arranged on n corners.

In a further variant, the filter carrier may be a filter slider on which all the filters are arranged. The filter slider can be moved along a straight line in the optical system. The filters of each side of the filter pair are arranged in a row one behind the other. The filters each have the same distance to each other for each side of the filter pair and within the filter pairs. The rows of each side of the filter pair are arranged in the direction of the straight line along which the filter slider is moved. The filter slider allows the filters of a filter pair to be moved together and brought into the two beam paths. As the filters are all arranged on the same filter slider, only this one slider needs to be moved when changing.

In a further variant, the filter carrier may have a plurality of individual sliders arranged in series in the direction of the beam paths, which together act as a filter carrier and are also considered such. Only the two filters of a single filter pair are arranged in each individual slider. In addition, two openings are provided in each individual slider. Each individual slider may be moved to a first position in which the filters of the filter pair are brought into the two beam paths. In addition, each individual slider can be moved to a second position in which the two openings are arranged in the beam paths. The individual slider with the selected filter pair is pushed to the first position and the other individual sliders are pushed to the second position such that the beam paths run through the openings of the other individual sliders and only pass through the selected filter pair. The individual sliders also offer the advantage that a plurality of filter pairs can be brought into the two beam paths simultaneously. Thus, for example, a high pass filter and a low pass filter may be used together.

### BRIEF DESCRIPTION OF THE DRAWINGS

Exemplary embodiments of the invention are shown in the drawings and explained in more detail in the following description.

FIGS. 1 a and b each show a schematic representation of a first embodiment of the optical system according to the invention with a filter wheel.

FIG. 2 shows a schematic representation of a second embodiment of the optical system according to the invention with a common filter slider.

FIG. 3 shows a schematic representation of a third embodiment of the optical system according to the invention with a plurality of individual sliders.

### EXEMPLARY EMBODIMENTS OF THE INVENTION

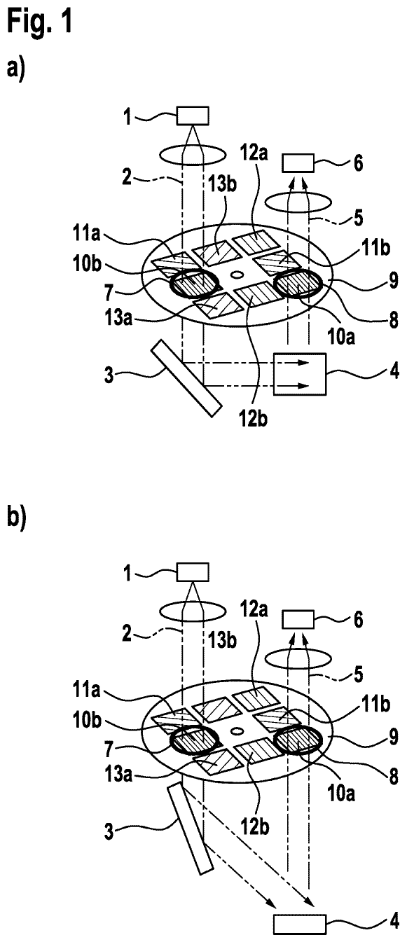

FIGS. 1 to 3 show a plurality of optical filters 10a, 10b, 11a, 11b, 12a, 12b, 13a, 13b. The filters 10a, 11a, 12a, 13a labeled with “a” together with the corresponding filters 10b, 11b, 12b, 13b labelled with “b” with the same number form filter pairs 10a & 10b, 11a & 11b, 12a & 12b, 13a & 13b. The filters of the same filter pair 10a & 10b, 11a & 11b, 12a & 12b, 13a & 13b are complementary. The filters 5a, 6a, 7a, 8a, 9a labelled with “a” which belong to one side of the filter pairs are henceforth referred to as the “first filter”. Accordingly, the filters 5b, 6b, 7b, 8b, 9b labelled with “b” which belong to the other side of the filter pairs are henceforth referred to as the “second filter”. The optical systems shown here are fluorescence measurement systems and are used for fluorescence spectroscopy. To this end, the first filters 10a, 11a, 12a, 13a are configured as band pass filters that only allow the excitation light to pass through, and the second filters 10b, 11b, 12b, 13b may be configured as high pass or low pass filters that block the excitation light and allow only the fluorescent light to pass through.

In FIGS. 1 a and b, a first embodiment of the optical system for fluorescence spectroscopy is shown. A broadband light source 1, for example a white LED, a phosphor-based light source or a gas discharge lamp, emits an excitation light. The excitation light runs along a first beam path 2 to a mirror 3 and is deflected by this in the direction of a sample 4. The sample 4 is held in a sample holder not shown. The sample 4 is excited by the excitation light and emits a fluorescent light along a second beam path 5. The fluorescent light runs along the second beam path 5 to a detector 6 and is received by it. The detector 6 is configured to detect at least selected detection bands. Preferably, a semiconductor detector, in particular a photodiode, is used here. In FIG. 1 a, the mirror 3 directs the excitation light laterally into the sample 4 such that the excitation light along the first beam path 2 is radiated from a different side than the fluorescent light is emitted along the second beam path 5. In FIG. 1 b, the mirror 3 directs the excitation light along the first beam path 2 into the sample 4 via the same side as the fluorescent light is emitted along the second beam path 5. In both cases, the first beam path 2 and the second beam path 5 only cross in sample 4. The optical system may have various optical elements that shape and direct the light. The exact configuration depends on the radiating characteristic of the light source 1, the active area of the detector 6 and the general sample and device concept. As examples, lenses, mirrors, deflection prisms, hollow mirrors, waveguides, holographic or diffractive optical elements may be employed. A first opening 7 is provided in the first beam path 2 and a second opening 8 is provided in the second beam path 5. The light culminates at the openings 7, 8.

In the first exemplary embodiment according to FIG. 1, it is provided that the filters 10a, 10b, 11a, 11b, 12a, 12b, 13a, 13b are arranged on a filter wheel 9 to cover the openings 7, 8. The filter wheel 9 is a circle disc and is rotatably mounted around a center of rotation 2 in its center. In order to rotate the filter wheel 9, the optical system comprises a mechanical or electromechanical device not shown here, with which the rotation can be controlled externally. As explained in detail below, the filters 10a, 10b, 11a, 11b, 12a, 12b, 13a, 13b are aligned with the openings 7, 8 and cover them. Only one filter pair 10a & 10b, 11a & 11b, 12a & 12b, 13a & 13b covers the two openings 7, 8 simultaneously. In this embodiment, the filter pairs 10a & 10b, 11a & 11b, 12a & 12b, 13a & 13b are arranged along a square whose center point lies in the center of rotation of the filter wheel 9. The first filters 10a, 11a, 12a, 13a are arranged in the corners of the square Q. A first concentric circle, not shown, runs through the corners of square Q with the center of rotation of the filter wheel 9 as the center point, such that the first filters 10a, 11a, 12a, 13a are arranged on the first circle. The second filters 10b, 11b, 12b, 13b of the associated filter pair 10a & 10b, 11a & 11b, 12a & 12b, 13a & 13b are arranged at the center points of the opposite sides of the square. Starting from the corner, the same opposite side is always selected, e.g., the left opposite side. A second concentric circle, also not shown, runs through these center points, such that the second filters 10b, 11b, 12b, 13b are arranged on the second circle. The radius of the second circle is less than the radius of the first circle; accordingly the distance from the center of rotation of the filter wheel 9 to the first filters 10a, 11a, 12a, 13a is greater than the distance from the center of rotation to the second filters 10b, 11b, 12b, 13b. The second opening 8 is arranged such that it falls on a corner (e.g., the right corner in FIG. 1) of the square and the first opening 7 is arranged such that it falls on the center point of the opposite side of the square. The openings 7, 8 can also be arranged the other way around. As the center of rotation of the filter wheel 9 and the center point of the square coincide, the first filters 10a, 11a, 12a, 13a in the corners of the square pass through the first opening 7 when the filter wheel 9 rotates due to the symmetry of the square and correspondingly the associated second filters 10b, 11b, 12b, 13b of the same filter pair 10a & 10b, 11a & 11b, 12a & 12b, 13a & 13b on the sides of the square pass through the second opening 8 simultaneously. The filters 10a, 11a, 12a, 13a and 10b, 11b, 12b, 13b are each arranged at the same distance from each other such that rotation for changing the filter pair 10a & 10b, 11a & 11b, 12a & 12b, 13a & 13b takes place at the same angle. The corners of the square and the center points of the sides of the square have different distances to the center of rotation of the filter wheel 9 and also do not lie on a common straight line with the center of rotation.

However, other geometries for the filters of the filter wheel, such as a pentagon or general n-corner, may be provided.

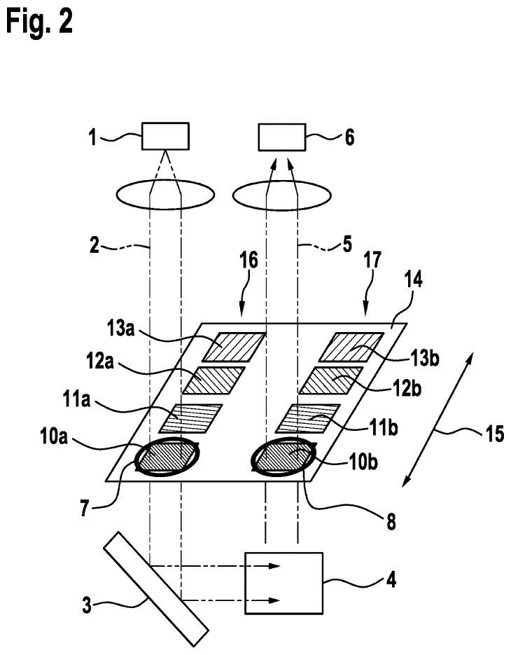

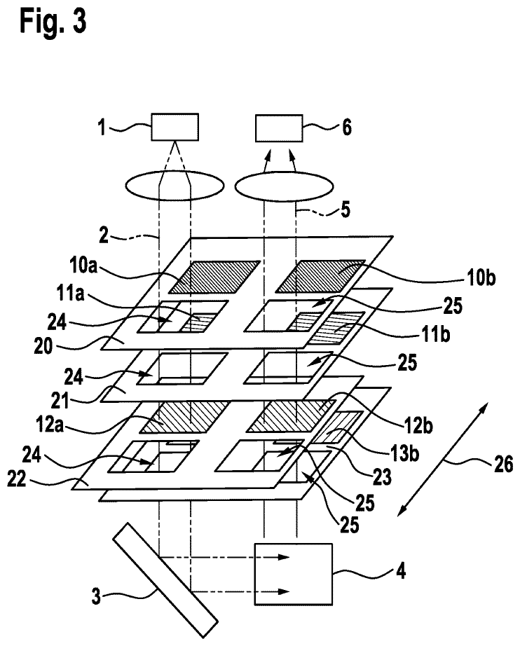

FIGS. 2 and 3 show a second and third embodiment of the optical system for fluorescent spectroscopy. The optical systems according to the second embodiment and according to the third embodiment differ from the first embodiment only in the filter carrier. For the remaining construction, reference is made to the above description. The optical system can be configured with regard to the mirror 3 and the profile of the first beam path 2 as shown in Figure 1a or as in FIG. 1 b.

In the second exemplary embodiment according to FIG. 2, it is provided that the filters 10a, 10b, 11a, 11b, 12a, 12b, 13a, 13b are arranged on a filter slider 14 to cover the openings 7, 8. The filter slider 14 may be moved along the displacement direction 14. The filters 10a, 11a, 12a, 13a of one side of the filter pair 10a & 10b, 11a & 11b, 12a & 12b, 13a & 13b are arranged in a row 16 one behind the other in the displacement direction 15. Similarly, the filters 10b, 11b, 12b, 13b of the side of the filter pair 10a & 10b, 11a & 11b, 12a & 12b, 13a & 13b are arranged in a row 17 one behind the other in the displacement direction 15, in the same order as the associated filter of the filter pair 10a & 10b, 11a & 11b, 12a & 12b, 13a & 13b in the other row 16. The distance between the rows 16, 17 is constant and the distances between the filters 10a, 11a, 12a, 13a and 10b, 11b, 12b, 13b in the respective rows 16 and 17 are equal. The openings 7, 8 are arranged above the two rows 16, 17 and are the same distance apart as the rows 16, 17. Here, the first opening 7 is arranged above the row 16 of the filters 10a, 11a, 12a, 13a of the one side of the filter pairs 10a & 10b, 11a & 11b, 12a & 12b, 13a & 13b, and the second opening 8 is arranged above the row 17 of the filters 10b, 11b, 12b, 13b of the other side of the filter pairs 10a & 10b, 11a & 11b, 12a & 12b, 13a & 13b. By moving the filter slider 14 along the displacement direction 15, a filter pair 10a & 10b, 11a & 11b, 12a & 12b, 13a & 13b simultaneously covers both openings 7, 8.

In the third embodiment according to FIG. 3, a plurality of individual sliders 20, 21, 22, 23 are provided, which together act as a filter carrier. The individual sliders 20, 21, 22, 23 are arranged one behind the other in the direction of the first beam path 2 and in the direction of the second beam path 5. A first individual slider 20 has a first filter pair 10a, 10b, a second individual slider 21 has a second filter pair 11a, 11b, a third individual slider 22 has a third filter pair 12a, 12b, and a fourth individual slider 23 has a fourth filter pair 13a, 13b. Each individual slider may be placed between a first position in which the two filters of the respective filter pair 10a & 10b, 11a & 11b, 12a & 12b, 13a & 13b are placed in the beam paths 2, 5 and a second position in which the two openings 24, 25 are placed in the two beam paths 2, 5 along a deflection direction. The individual sliders 20, 21, 22, 23 may be moved independently of each other. In order to displace the individual sliders 20, 21, 22, 23, the optical system comprises a mechanical or electromechanical device not shown here, with which the displacement can be controlled externally. The filters of each filter pair 10a & 10b, 11a & 11b, 12a & 12b, 13a & 13b each have the same distance to each other. Each individual slider 20, 21, 22, 23 also has an opening 24 arranged in the displacement direction 26 adjacent to a filter 10a, 11a, 12a, 13a of one side of the filter pairs 10a & 10b, 11a & 11b, 12a & 12b, 13a & 13b, and an opening 25 arranged in the displacement direction 26 adjacent to a filter 10b, 11b, 12b, 13b of the other side of the filter pairs 10a & 10b, 11a & 11b, 12a & 12b, 13a & 13b. The openings 24, 25 are the same distance to each other as the filters of each filter pair 10a & 10b, 11a & 11b, 12a & 12b, 13a & 13b, and are offset the same distance in the same direction from the respective filters 10a, 10b, 11a, 11b, 12a, 12b, 13a, 13b. The openings 24 are configured such that the first beam path 2 runs unhindered therethrough and the opening 25 is configured such that the second beam path 5 runs unhindered therethrough when the associated individual slider 20, 21, 22, 23 in the second position moves the openings 24, 25 into the beam paths 2, 5. The openings 24, 25 and the filters (10a, 10b, 11a, 11b, 12a, 12b, 13a, 13b) serve as an opening in this respect. For example, in FIG. 3, the third individual slider 22 is in the first position and the other individual sliders 20, 21, 23 are in the second position. The excitation light thus passes along the first beam path 2 through the opening 24 of the first individual slider 20, the opening 24 of the second individual slider 21, the filter 12a of the third individual slider 22 and the opening 24 of the fourth individual slider 23. Similarly, the fluorescent light passes along the second beam path 5 through the opening 25 of the fourth individual slider 23, the filter 12b of the third individual slider 22, the opening 25 of the second individual slider 21 and the opening 25 of the first individual slider 20.

1. An optical system comprising:
a light source;
a detector; and
a sample holder,
wherein
a first beam path runs from the light source to the sample holder and a second beam path, which is separated from the first beam path, runs from the sample holder to the detector,
the optical system includes a filter carrier, which has a plurality of filters,
a filter pair is formed by two filters of the plurality of filters, and
the filter carrier is arranged in the optical system such that the first beam path runs through a first filter of the filter pair and the second beam path runs through a second filter of the filter pair.

2. The optical system according to claim 1, wherein:
the optical system is a fluorescence measuring system;
an excitation light runs along the first beam path through the first filter of the filter pair; and
a fluorescence light runs separate from the excitation light along the second beam path through the second filter of the filter pair.

3. The optical system according to claim 1, wherein the first and second filters of the filter pair block different frequency ranges.

4. The optical system according to claim 1, wherein:
the filter carrier is a filter wheel; and
the filter wheel is rotatably supported about a center of rotation.

5. The optical system according to claim 4, wherein:
the first and second filters of the filter pair have different distances from the center of rotation; and/or
the first and second filters of the filter pair and the center of rotation do not lie on a common straight line.

6. The optical system according to claim 4, wherein the first and second filters are arranged along two concentric circles about the center of rotation.

7. The optical system according to claim 1, wherein:
the filter carrier is a filter slider;
the filter slider is configured to move along a straight line;
the filter pair is one of a plurality of filter pairs, each of the plurality of filter pairs including a respective first and second filter; and
the each of the respective first and second filters are arranged in respective rows in the direction of the straight line.

8. The optical system according to claim 1, wherein:
the filter carrier comprises a plurality of single sliders arranged behind each other in the direction of the beam paths;
the filter pair is one of a plurality of filter pairs; and
a respective filter pair of the plurality of filter pairs and two openings are provided in each of the plurality of sliders and each of the plurality of sliders is configured to move to a respective first position, in which the respective first and second filters are arranged in the first and or second beam path, respectively, and to a second position in which each of the two openings is arranged in a respective one of the first and second beam paths.

9. A method of using a filter carrier in an optical system having a light source, a detector and a sample holder, comprising:
providing a first beam path of the optical system which runs from the light source to the sample holder;
providing a second beam path of the optical system, which is separate from the first beam path, which runs from the sample holder to the detector;
providing a filter carrier, which comprises a plurality of filters, wherein a filter pair is formed by a first and a second filter; and
arranging the filter carrier in the optical system such that the first beam path runs through the first filter and the second beam path runs through the second filter.
